(19) United States
(12) Patent Application Publication
(10) Pub. No.: US 2017/0015946 A1
(43) Pub. Date: Jan. 19, 2017

(54) GLYCOL ETHER SOLVENTS IN LIQUID CLEANING COMPOSITIONS TO REMOVE STAINS FROM SURFACES

(71) Applicant: The Procter & Gamble Company, Cincinnati, OH (US)

(72) Inventors: Aicha DKIDAK, Brussels (BE); Denis Alfred GONZALES, Brussels (BE); Marina Jozefa HERMIE, Hever (BE); Robby Renilde Francois KEULEERS, Brussels (BE); James Robert TINLIN, Brussels (BE)

(21) Appl. No.: 15/202,748

(22) Filed: Jul. 6, 2016

(30) Foreign Application Priority Data
Jul. 13, 2015 (EP) 15176529.4

(51) Int. Cl. C11D 3/20; C11D 1/66; C11D 1/75; B08B 1/00; C11D 1/83; C11D 1/94; C11D 1/90; C11D 11/00; C11D 3/43; C11D 1/22

(52) U.S. Cl. CPC C11D 3/2068; C11D 3/43; C11D 1/66; C11D 1/75; C11D 1/22; C11D 1/83; C11D 1/94; C11D 1/90; C11D 11/0023; B08B 1/006

(57) ABSTRACT

Glycol ether solvents can be used in liquid cleaning compositions to improve the removal of hydrophobic stains from hard surfaces, and also improve the sudsing profile of the composition.

### FIELD OF THE INVENTION

Uses and methods for removing stains from surfaces, especially hydrophobic stains, and for providing improved suds longevity, especially during stain removal.

### BACKGROUND OF THE INVENTION

Hydrophobic stains, especially oils, fats, and polymerised grease, are often present on surfaces such as floors, kitchen counters, pots, pans, and dishes, and even on fabrics. Such hydrophobic stains are challenging to remove from surfaces, especially ceramics and surfaces that are at least partially porous, and especially after the hydrophobic material has been left on the surface for extended periods. Moreover, during domestic (in home) use, compositions which are known as being tough on oils and grease can often be harsh on skin, especially sensitive skin, especially those having a high pH.

Moreover, high pH compositions can be challenging for the stability of many functional ingredients, including enzymes, perfumes, dyes preservatives, and the like. In addition, high pH can result in damage to delicate surfaces.

Moreover, suds longevity can be challenging, especially in the presence of hydrophobic residues. Since users can equate low suds with low cleaning effectiveness, especially when treating hard to remove stains, such low suds can lead to dissatisfaction during use of the cleaning composition.

As such, a need remains for stable compositions which provide improved means of removing such stains from surfaces, especially porous or delicate surfaces.

US 2005/0233925 A1 relates to compositions comprising an organic solvent, for removing polymerised grease. US2004/0157763 A1 relates to compositions comprising an organic solvent and malodour control agent.

### SUMMARY OF THE INVENTION

The present invention relates to the use of glycol ether solvents in liquid cleaning compositions comprising surfactant and having a pH of less than 10, for treating hydrophobic stains from surfaces, or for providing suds longevity. The present invention further related to a method of removing hydrophobic stains from a surface. The present invention further relates to liquid cleaning composition for treating hydrophobic stains on surfaces, having a pH of less than 10 and comprising: a surfactant, a glycol ether solvent, and a chelant.

### DETAILED DESCRIPTION OF THE INVENTION

Glycol ether solvents, as described herein, can be used to formulate stable liquid cleaning compositions having a pH of less than 10, to improve the treatment of hydrophobic stains from surfaces, especially delicate surfaces. Compositions comprising such glycol ether solvents have been found to be particularly suited for treating hydrophobic stains selected from oils, fats, polymerized grease, and mixtures thereof.

Oils are nonpolar substances which are liquid at ambient temperatures (21° C.), and are both hydrophobic (immiscible with water) and lipophilic (miscible with other oils and organic solvents). Oils typically have a high carbon and hydrogen content. Oil includes classes of chemical compounds that may be otherwise unrelated in structure, properties, and uses. Oils may be derived from animal, vegetable, or petrochemicals sources. They are typically used for food, fuel, lubrication, and the manufacture of paints, plastics, and other materials.

Fats are soft greasy solids at ambient temperatures (21° C.), and are also both hydrophobic (immiscible with water) and lipophilic (miscible with other oils and organic solvents). Fats may be animal, vegetable, or petrochemical in origin. They are also typically used for food, fuel, lubrication, and the manufacture of paints, plastics, and other materials.

Polymerised grease are cooked-, baked- or burnt-on oils and fats that have been heated to a temperature, of left sufficiently long, that they polymerise and typically also have an increased viscosity.

Liquid cleaning compositions comprising the glycol ether solvents, as described herein, are particularly suitable for treating oils, fats, and polymerized grease which have been derived from animal, or vegetable sources, especially vegetable sources, and most especially vegetable sources selected from: sesame oil, canola oil, olive oil, rapeseed oil, coconut oil, corn oil, peanut oil, sunflower oil and mixtures thereof.

Moreover, such compositions also provide a more enduring suds profile, even during the treatment of hydrophobic stains. The improved suds sustainability provides the users with an indication of the continued effectiveness of the liquid cleaning composition during use.

As defined herein, “essentially free of” a component means that no amount of that component is deliberately incorporated into the respective premix, or composition. Preferably, “essentially free of” a component means that no amount of that component is present in the respective premix, or composition.

All percentages, ratios and proportions used herein are by weight percent of the premix, unless otherwise specified. All average values are calculated “by weight” of the premix, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Glycol Ether Solvents:

The glycol ether solvents, described herein, provide improved removal of hydrophobic stains, especially stains comprising oils, fats, and polymerized grease which have been derived from animal, or vegetable sources, more especially vegetable oils. The glycol ether solvents are selected from the glycol ethers of Formula 1 or Formula 2.

R₁O(R₂O)ₙR₃ Formula 1:
wherein
R₁ is a linear or branched C₄, C₅ or C₆ alkyl, a substituted or unsubstituted phenyl, preferably n-butyl. Benzyl is one of the substituted phenyls for use herein.
R₂ is ethyl or isopropyl, preferably isopropyl
R₃ is hydrogen or methyl, preferably hydrogen
n is 1, 2 or 3, preferably 1 or 2

R₄O(R₅O)ₘR₆ Formula 2:
wherein
R₄ is n-propyl or isopropyl, preferably n-propyl
R₅ is isopropyl
R₆ is hydrogen or methyl, preferably hydrogen
m is 1, 2 or 3 preferably 1 or 2

Suitable glycol ether solvents according to Formula 1 include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula 1 are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

Most preferred glycol ethers according to Formula 1 are propyleneglycol n-butyl ether, dipropyleneglycol n-butyl ether, and mixtures thereof.

Suitable glycol ether solvents according to Formula 2 include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula 2 are propyleneglycol n-propyl ether, dipropyleneglycol n-propyl ether, and mixtures thereof.

Most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, more particularly from the E-series (ethylene glycol based) Glycol Ethers and the P-series (propylene glycol based) Glycol Ethers line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

The glycol ether solvent is typically present at a level of less than 10%, more preferably from 1% 25 to 7% by weight of the composition.

The composition can comprise a co-solvent, such as solvents selected from the group consisting of C2-C4 alcohols, C2-C4 polyols, poly alkylene glycol and mixtures thereof.

### Liquid Cleaning Composition:

The liquid cleaning composition, for use in the present invention, comprises a glycol ether solvent, as described herein.

In a preferred embodiment, the liquid cleaning compositions herein are aqueous compositions.

Therefore, they may comprise from 30% to 99.5% by weight of the total composition of water, preferably from 40% to 98% and more preferably from 50% to 85%.

The pH of the liquid cleaning composition is less than 10. The pH can be from 7.0 to 10, more preferably from 8.0 to 9.5. It is believed that the aforementioned pH range, in combination with the glycol ether solvent, results in improved greasy soil and particulate greasy soil cleaning removal, while being safe on more delicate. Accordingly, the compositions herein may further comprise an acid or base to adjust pH as appropriate.

Alternatively, and especially where limescale treatment is desired, the pH can be acidic. That is, less than 7, preferably from 1 to 6.5, more preferably from 1.5 to 3.5, most preferably from 2.0 to 4.

A suitable acid for use herein is an organic and/or an inorganic acid. A preferred organic acid for use herein has a pKa of less than 6. A suitable organic acid is selected from the group consisting of: citric acid, lactic acid, glycolic acid, succinic acid, glutaric acid and adipic acid and mixtures thereof. A suitable inorganic acid can be selected from the group consisting of: hydrochloric acid, sulphuric acid, phosphoric acid and mixtures thereof.

A typical level of such acids, when present, is from 0.01% to 8.0% by weight of the total composition, preferably from 0.5% to 5.0% and more preferably from 1.0% to 3.0%.

The compositions herein can comprise lactic acid. It has been found that the presence of lactic acid additionally provides antimicrobial/disinfecting benefits to the compositions according to the present invention. The compositions according to the present invention may comprise up to 10% by weight of the total composition of lactic acid, preferably from 0.1% to 6%, more preferably from 0.2% to 5.0%, even more preferably from 0.5% to 4.0%, and most preferably from 1.0% to 3.0%.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, K₂CO₃, Na₂CO₃ and alkanolamines (such as monoethanolamine, triethanolamine, aminomethylpropanol, and mixtures thereof). Alkanolamines, especially methanolamine, are particularly preferred.

Typical levels of such bases, when present, are from 0.01% to 5.0% by weight of the total composition, preferably from 0.05% to 3.0% and more preferably from 0.1% to 2.0%.

For improved stain penetration, the liquid hard surface treatment composition preferably has a reserve alkalinity of from about 0.1 to about 1, preferably from 0.2 to 0.7, more preferably from 0.3 to 0.5 expressed as g NAOH/100 ml of composition at a pH of 7.

All ratios are calculated as a weight/weight level, unless otherwise specified.

### Surfactant:

The liquid cleaning composition comprises a surfactant. Preferably, the liquid cleaning composition comprises greater than 3% by weight of a surfactant. Preferably, the composition comprises surfactant at a level of from 3% to 60%, more preferably from 5% to 50% and most preferably from 8% to 40% by weight of the composition.

For improved release of stains, the surfactant and the glycol ether solvent are in a weight ratio of from 5:1 to 1:1.

The surfactant system preferably comprises an anionic surfactant, more preferably an alkoxylated sulfate anionic surfactant. The system can optionally comprise an amphoteric, zwitterionic, nonionic surfactant and mixtures thereof.

Preferably, the surfactant system comprises alkyl sulfates and/or alkyl ethoxy sulfates; more preferably a combination of alkyl sulfates and/or alkyl ethoxy sulfates with a combined average ethoxylation degree of less than 5, preferably less than 3, more preferably less than 2 and more than 0.5 and an average level of branching of from about 5% to about 40%.

Preferably, the composition of the present invention will further comprise amphoteric and/or zwitterionic surfactant, more preferably an amine oxide and/or betaine surfactant.

The most preferred surfactant system for the detergent composition of the present invention will therefore comprise: (i) 1% to 40%, preferably 6% to 32%, more preferably 8% to 25% weight of the total composition of an anionic surfactant, preferably an alkoxylated sulfate surfactant (2) combined with 0.01% to 20% wt, preferably from 0.2% to 15% wt, more preferably from 0.5% to 10% by weight of the composition of amphoteric and/or zwitterionic and/or nonionic surfactant, more preferably an amphoteric and even more preferred an amine oxide surfactant and a nonionic surfactant. It has been found that such surfactant system in combination with the glycol ether solvent according to the invention will provide the excellent grease cleaning required from a hand dishwashing detergent.

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C 8-C 22 alkyl, or acyl group. Such surfactants are employed in the form of water-soluble salts and the salt-forming cation usually is selected from sodium, potassium, ammonium, magnesium and mono-, di- or tri-C 2-C 3 alkanolammonium, with the sodium, cation being the usual one chosen.

The anionic surfactant can be a single surfactant but usually it is a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

Preferably the anionic surfactant is alkoxylated, more preferably, an alkoxylated branched anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the branched anionic surfactant is a mixture of surfactants, the alkoxylation degree is the weight average alkoxylation degree of all the components of the mixture (weight average alkoxylation degree). In the weight average alkoxylation degree calculation the weight of anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each anionic surfactant of the mixture and alkoxylation degree is the number of alkoxy groups in each anionic surfactant.

Preferably the anionic surfactant to be used in the detergent of the present invention is a branched anionic surfactant having a level of branching of from about 5% to about 40%, preferably from about 10 to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the anionic surfactant used in the detergent of the invention. Most preferably the branched anionic surfactant is selected from alkyl sulphates, alkyl ethoxy sulphates, and mixtures thereof.

The branched anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Preferably, the surfactant system comprises at least 50%, more preferably at least 60% and preferably at least 70% of branched anionic surfactant by weight of the surfactant system, more preferably the branched anionic surfactant comprises more than 50% by weight thereof of an alkyl ethoxylated sulphate having an ethoxylation degree of from about 0.2 to about 3 and preferably a level of branching of from about 5% to about 40%.

### Sulphate Surfactants

Suitable sulphate surfactants for use herein include water-soluble salts of C8-C18 alkyl or hydroxyalkyl, sulphate and/or ether sulfate. Suitable counterions include alkali metal cation or ammonium or substituted ammonium, but preferably sodium.

The sulphate surfactants may be selected from C8-C18 primary, branched chain and random alkyl sulphates (AS); C8-C18 secondary (2,3) alkyl sulphates; C8-C18 alkyl alkoxy sulphates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulphates include, those based on Neodol alcohols ex the Shell company, Lial—Isalchem and Safol ex the Sasol company, natural alcohols ex The Procter & Gamble Chemicals company.

Preferably, the branched anionic surfactant comprises at least 50%, more preferably at least 60% and especially at least 70% of a sulphate surfactant by weight of the branched anionic surfactant. Especially preferred detergents from a cleaning view point art those in which the branched anionic surfactant comprises more than 50%, more preferably at least 60% and especially at least 70% by weight thereof of sulphate surfactant and the sulphate surfactant is selected from the group consisting of alkyl sulphate, alkyl ethoxy sulphates and mixtures thereof. Even more preferred are those in which the branched anionic surfactant has a degree of ethoxylation of from about 0.2 to about 3, more preferably from about 0.3 to about 2, even more preferably from about 0.4 to about 1.5, and especially from about 0.4 to about 1 and even more preferably when the anionic surfactant has a level of branching of from about 10% to about 35%, %, more preferably from about 20% to 30%.

### Sulphonate Surfactants

Suitable sulphonate surfactants for use herein include water-soluble salts of C8-C18 alkyl or hydroxyalkyl sulphonates; C11-C18 alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

Nonionic surfactant, when present, is comprised in a typical amount of from 0.1% to 30%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Other suitable nonionic surfactants include alkyl polyglycosides. Alkyl polyglycosides are biodegradable nonionic surfactants which are well known in the art, and can also be used in the compositions of the present invention. Suitable alkyl polyglycosides can have the general formula CₙH₂ₙ₊₁O(C₆H₁₀O₅)ₓH wherein n is preferably from 9 to 16, more preferably 11 to 14, and x is preferably from 1 to 2, more preferably 1.3 to 1.6.

### Amphoteric Surfactant

Preferred amphoteric surfactants include amine oxide surfactants. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1-n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide can further comprise two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

### Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ—[CH(OH)—CH₂]_{y}—Y— (I) wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, cocoamidopropylbetaine.

### Optional Ingredients:

Chelant:

The liquid cleaning composition preferably comprises a chelating agent or crystal growth inhibitor. Suitable chelating agents, in combination with the surfactant, improve the shine benefit, as well as specific stain removal performance benefits, such as on grease and bleach sensitive stains. More particularly, water hardness can make it harder for cleaning compositions to dislodge particulates. Chelants, especially chelants are selected from the group consisting of: aminocarboxylate chelant, more preferably a salt of glutamic-N,N-diacetic acid, improve the removal of particulate soils which are stuck to hydrophobic stains, and hence, improve the removal of such hydrophobic stains.

Hard water can also result in the formation of insoluble salts of fatty acids being formed, which reduce suds formation. As such, chelant, and particularly the aforementioned chelants, results in more sustained sudsing, especially in the presence of hard water.

The chelant can be incorporated into the compositions in amounts ranging from 0.05% to 5.0% by weight of the total composition, preferably from 0.1% to 3.0%, more preferably from 0.2% to 2.0% and most preferably from 0.25% to 1.5%.

Suitable phosphonate chelating agents include ethylene diamine tetra methylene phosphonates, and diethylene triamine penta methylene phosphonates (DTPMP), and can be present either in their acid form or as salts.

A preferred biodegradable chelating agent for use herein is ethylene diamine N,N′-disuccinic acid, or alkali metal, or alkaline earth, ammonium or substitutes ammonium salts thereof or mixtures thereof, for instance, as described in U.S. Pat. No. 4,704,233. A more preferred biodegradable chelating agent is L-glutamic acid N,N-diacetic acid (GLDA) commercially available under tradename Dissolvine 47S from Akzo Nobel.

Suitable amino carboxylates include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). Most preferred aminocarboxylate used herein is diethylene triamine pentaacetate (DTPA) from BASF. Further carboxylate chelating agents for use herein include salicylic acid, aspartic acid, glutamic acid, glycine, malonic acid or mixtures thereof.

Thickener:

The liquid cleaning composition can comprise a thickener. An increased viscosity, especially low shear viscosity, provides longer contact time and therefore improved penetration of greasy soil and/or particulated greasy soil to improve cleaning effectiveness, especially when applied neat to the surface to be treated, especially when the surface is not horizontal. Moreover, a high low shear viscosity improves the phase stability of the liquid cleaning composition.

Suitable thickeners include polyacrylate based polymers, preferably hydrophobically modified polyacrylate polymers; hydroxyl ethyl cellulose, preferably hydrophobically modified hydroxyl ethyl cellulose, xanthan gum, hydrogenated castor oil (HCO) and mixtures thereof.

Preferred thickeners are polyacrylate based polymers, preferably hydrophobically modified polyacrylate polymers. Preferably a water soluble copolymer based on main monomers acrylic acid, acrylic acid esters, vinyl acetate, methacrylic acid, acrylonitrile and mixtures thereof, more preferably copolymer is based on methacrylic acid and acrylic acid esters having appearance of milky, low viscous dispersion. Most preferred hydrologically modified polyacrylate polymer is Rheovis® AT 120, which is commercially available from BASF.

The most preferred thickener used herein is a methacrylic acid/acrylic acid copolymer, such as Rheovis® AT 120, which is commercially available from BASF.

When used, the liquid cleaning composition comprises from 0.1% to 10.0% by weight of the total composition of said thickener, preferably from 0.2% to 5.0%, more preferably from 0.2% to 2.5% and most preferably from 0.2% to 2.0%.

Polymers:

The liquid cleaning composition may comprise a polymer. For instance, a polymer further improving the grease removal performance of the liquid cleaning composition due to the specific sudsing/foaming characteristics they provide to the composition. Suitable polymers for use herein are disclosed in co-pending EP patent application EP2272942 (09164872.5) and granted European patent EP2025743 (07113156.9).

The polymer can be selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

Typically, the liquid cleaning composition may comprise from 0.005% to 5.0% by weight of the total composition of said polymer, preferably from 0.10% to 4.0%, more preferably from 0.1% to 3.0% and most preferably from 0.20% to 1.0%.

Fatty Acid:

The liquid cleaning composition may comprise a fatty acid as a highly preferred optional ingredient, particularly as suds supressors. Fatty acids are desired herein as they reduce the sudsing of the liquid cleaning composition when the composition is rinsed off the surface to which it has been applied.

Suitable fatty acids include the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms. Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil. For example coconut fatty acid is commercially available from KLK OLEA under the name PALMERAB1211.

Typically, the liquid cleaning composition may comprise up to 6.0% by weight of the total composition of said fatty acid, preferably from 0.1% to 3.0%, more preferably from 0.1% to 2.0% and most preferably from 0.15% to 1.5% by weight of the total composition of said fatty acid.

Branched Fatty Alcohol:

The liquid cleaning composition may comprise a branched fatty alcohol, particularly as suds suppressors. Suitable branched fatty alcohols include the 2-alkyl alkanols having an alkyl chain comprising from 6 to 16, preferably from 7 to 13, more preferably from 8 to 12, most preferably from 8 to 10 carbon atoms and a terminal hydroxy group, said alkyl chain being substituted in the α position (i.e., position number 2) by an alkyl chain comprising from 1 to 10, preferably from 2 to 8 and more preferably 4 to 6 carbon atoms. Such suitable compounds are commercially available, for instance, as the Isofol® series such as Isofol® 12 (2-butyl octanol) or Isofol® 16 (2-hexyl decanol) commercially available from Sasol

Typically, the liquid cleaning composition may comprise up to 2.0% by weight of the total composition of said branched fatty alcohol, preferably from 0.10% to 1.0%, more preferably from 0.1% to 0.8% and most preferably from 0.1% to 0.5%.

Other Optional Ingredients:

The liquid compositions may comprise a variety of other optional ingredients depending on the technical benefit aimed for and the surface treated. Suitable optional ingredients for use herein include perfume, builders, other polymers, conditioning polymers, surface modifying polymers, soil flocculating polymers, structurants, emmolients, humectants, skin rejuvenating actives, enzymes, carboxylic acids, scrubbing particles, bleach and bleach activators, buffers, bactericides, hydrotropes, colorants, stabilisers, radical scavengers, abrasives, soil suspenders, brighteners, anti-dusting agents, dispersants, dye transfer inhibitors, pigments, silicones, dyes, opacifiers, perfumes, malodor control agents, beads, pearlescent particles, microcapsules, inorganic cations such as alkaline earth metals such as Ca/Mg-ions, antibacterial agents, preservatives and pH adjusters and buffering means.

### Method of Cleaning a Surface:

Liquid cleaning compositions described are suitable for cleaning household surfaces. In particular, such compositions are particularly useful for removing stains, especially hydrophobic stains, and most especially hydrophobic stains selected from the group consisting of: oils, fats, polymerized grease, and mixtures thereof.

The method described herein is particularly suited for cleaning surfaces, particularly those found in households, especially domestic households. Surfaces to be cleaned include kitchens and bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments.

The method described herein is also suitable for treating kitchenware, such as pots, pans, plates, bowls, cups, glasses, cutlery, and the like, for instance, using liquid dish cleaning compositions.

The method described herein is also suited for treating hydrophobic stains on porous surfaces, such as textile, granite, ceramic, marble, travertine, slate, limestone, and wood surfaces, especially hard surfaces such as granite, ceramic, marble, travertine, slate, limestone, and wood surfaces.

The method described herein is also suited for treating hydrophobic stains on table ware such as those selected from the group consisting of: ceramics, glass, metal cutlery, and combinations thereof.

The preferred method of cleaning comprises the steps of: optionally pre-wetting the surface, applying the liquid cleaning composition, and washing the surface with water.

The liquid cleaning composition can be applied neat to the surface, or first diluted. When diluted, the liquid cleaning composition is preferably diluted to a dilution level of from 0.001% to 10% by volume before application. In preferred embodiments, the liquid cleaning composition may be diluted to a level of from 0.005% to 5.0% by volume. The liquid cleaning composition may be diluted to a level of from 0.01% to 2% by volume, especially where the liquid cleaning composition has a total surfactant level of greater than or equal to 5% by weight. Where the liquid cleaning composition has a total surfactant level of less than 5% by weight, the liquid cleaning composition may be diluted to a level of from 0.7% to 1.4% by volume. In preferred embodiments, the liquid cleaning composition is diluted with water.

The dilution level is expressed as a percent defined as the fraction of the liquid cleaning composition, by volume, with respect to the total amount of the diluted composition. For example, a dilution level of 5% by volume is equivalent to 50 ml of the liquid cleaning composition being diluted to form 1000 ml of diluted composition.

The diluted composition can be applied by any suitable means, including using a mop, sponge, or other suitable implement.

When applied to the surface, the liquid cleaning composition preferably comprises surfactant, present at a level above the critical micelle concentration. The measurement of surface tension is well known in the art, and can be measured as the concentration at which surface tension becomes independent of the surfactant concentration, measured at 21° C. More preferably, the liquid cleaning composition comprises surfactant at a level of from 1 to 100, preferably 2 to 10 times the critical micelle concentration.

The methods of the present invention are particularly suited to domestic use, since the liquid cleaning compositions of use herein are less harsh to the skin, even when applied neat.

The hard surface may be rinsed, preferably with clean water, in an optional further step.

Alternatively, and especially for particularly dirty or greasy spots, the liquid cleaning composition can be applied neat to the hard surface. It is believed that the combination of solvent, surfactant, and pH results in improved penetration of the stain, and especially hydrophobic stains, leading to improved surfactancy action and stain removal, while being safer for the skin.

By “neat”, it is to be understood that the liquid cleaning composition is applied directly onto the surface to be treated without undergoing any significant dilution, i.e., the liquid cleaning composition herein is applied onto the hard surface as described herein, either directly or via an implement such as a sponge, without first diluting the composition. By significant dilution, what is meant is that the composition is diluted by less than 10%, preferably less than 5%, more preferably less than 3% by volume of the composition. Such dilutions can arise from the use of damp implements to apply the composition to the hard surface, such as sponges which have been “squeezed” dry.

In another preferred embodiment of the present invention said method of cleaning a hard surface includes the steps of applying, preferably spraying, said liquid cleaning composition onto said hard surface, leaving said liquid cleaning composition to act onto said surface for a period of time to allow said composition to act, with or without applying mechanical action, and optionally removing said liquid cleaning composition, preferably removing said liquid cleaning composition by rinsing said hard surface with water and/or wiping said hard surface with an appropriate instrument, e.g., a sponge, a paper or cloth towel and the like. Such compositions can be provided in a spray dispenser.

### Methods:

A) pH measurement:

The pH is measured as a 10 wt % product solution in deionised water at 20° C., using a Sartarius PT-10P pH meter with gel-filled probe (such as the Toledo probe, part number 52 000 100), calibrated according to the instructions manual.

B) Reserve alkalinity:

The reserve alkalinity is measured to pH 7.0 via titration of a 1% solution of the composition using g sodium hydroxide solution, with 100 grams of product at 20° C.

C) Reserve acidity:

The reserve acidity is measured to pH 7.0 via titration of a 1% solution of the composition using g hydrochloric acid, with 100 grams of product at 20° C.

### Examples

The following liquid hard surface cleaning compositions were prepared by simple mixing:

| | A | B | C | D | E* |
|---|---|---|---|---|---|
| | wt % | wt % | wt % | wt % | wt % |
| HLAS¹ | 1.80 | 1.80 | 1.80 | 1.80 | 1.80 |
| Neodol C9/11 EO8² | 6.20 | 6.20 | 6.20 | 6.20 | 6.20 |
| C12-14 Dimethyl Amine Oxide³ | 1.50 | 1.50 | 1.50 | 1.50 | 1.50 |
| 2-butyl octanol⁴ | 0.10 | 0.10 | 0.10 | 0.10 | 0.10 |
| TPK Fatty Acid | 1.00 | 1.00 | 1.00 | 1.00 | 1.00 |
| Sodium Carbonate | 0.55 | 0.55 | 0.55 | 0.55 | 0.55 |
| Citric Acid | 0.30 | 0.30 | 0.30 | 0.30 | 0.30 |
| Sodium hydroxide | 0.73 | 0.73 | 0.73 | 0.73 | 0.73 |
| DTPMP⁵ | 0.30 | 0.30 | 0.30 | 0.30 | 0.30 |
| Propylene glycol n-propyl ether⁶ | 2.00 | — | — | — | — |
| Dipropylene glycol n-propyl ether⁷ | — | 2.00 | — | — | — |
| Propylene glycol n-butyl ether⁸ | — | — | 2.00 | — | — |
| Dipropylene glycol n-butyl ether⁹ | — | — | — | 2.00 | — |
| Hydrophobically modified-polyacrylate¹⁰ | 0.82 | 0.82 | 0.82 | 0.82 | 0.82 |
| Minors (including perfume, dyes, and | up to | up to | up to | up to | up to |
| preservative) and Water | 100% | 100% | 100% | 100% | 100% |
| pH | 10 | 10 | 10 | 10 | 10 |

*Comparative
¹linear alkylbenzene sulphonic acid, commercially available from Huntsman
²nonionic surfactant commercially available from Shell.
³amine oxide nonionic surfactant commercially available from Huntsman
⁴commercially available from Sasol as Isofol 12 ®.
⁵diethylene triamine penta methylene phosphonate, available from Monsanto
⁶Dowanol PnP, from The Dow Chemical Company
⁷Dowanol DPnP, from The Dow Chemical Company
⁸Dowanol PnB, from The Dow Chemical Company
⁹Dowanol DPnB, from The Dow Chemical Company
¹⁰Sokalan ® AT 120, which is commercially available from BASF

The ability of the compositions to penetrate oil was assessed by measuring the breakthrough time, using the following methodology:

35 gram of water solution containing 0.15% by weight of xanthan gum (supplied by Keltrol™ RD from CP-kelco) was poured into a glossy white ceramic dish plate (Supplied by Ikea—Item: S.Pryle #13781 diameter 26.5 cm).

Olive oil (Sold by Unilever under the Bertoli brand, item number L5313R HO0756 MI0002) was dyed red through the addition of 0.05% by weight of red dye (Waxoline Red, red dye pigment supplied by Avecia), stirring for 1 hour in order to provide a homogeneous dye distribution. Then 2.5 grams of the dyed olive oil was delicately deposited onto the water surface thus forming a thin disk of oil layer. The oil disk diameter was measured to ensure that the diameter did not exceed a variation amongst the replicates of more than 20% from the average value.

1 drop of the hard surface cleaning composition was delicately deposited on to the oil layer, in the middle of the oil disk from a 5 ml Pasteur pipette (Supplied by VWR—Item: 5 ml #612-1684), from a height of less than 5 mm.

The breakthrough time was measured as the time recorded from the deposition of the solution drop to the opening of the oil disk identified by the appearance of the water layer in the middle of the oil disk. 8 replicates were required per sample to calculate the average breakthrough time.

The average breakthrough time is shown in the table below:

| | A | B | C | D | E |
|---|---|---|---|---|---|
| Average breakthrough time (s) | 28.0 | 26.6 | 29.8 | 27.1 | 33.8 |

* Comparative

As can be seen from the table above, compositions of the present invention, comprising the glycol ether solvent according to formula I (Dowanol PnB, Dowanol DPnB) or formula II (Dowanol PnP, Dowanol DPnP), improve the penetration of the composition through hydrophobic material, such as oil. Since the solvent improves penetration of the liquid composition into the stain, the improved surfactancy in combination with the alkaline pH improves the dispersion of such hydrophobic stains.

The ability of glycol ether solvents according to the invention to improvehydrophobic stain dispersion has also been confirmed with acidic formulations.

The following liquid hard surface cleaning compositions were prepared by simple mixing:

| | F | G | H | I | J* |
|---|---|---|---|---|---|
| | wt % | wt % | wt % | wt % | wt % |
| HLAS¹ | 3.0 | 3.0 | 3.0 | 3.0 | 3.0 |
| Neodol 91-8² | 6.5 | 6.5 | 6.5 | 6.5 | 6.5 |
| Citric acid¹¹ | 1.0 | 1.0 | 1.0 | 1.0 | 1.0 |
| Formic acid¹² | 2.0 | 2.0 | 2.0 | 2.0 | 2.0 |
| Propylene glycol n-propyl ether⁶ | 5.00 | — | — | — | — |
| Dipropylene glycol n-propyl ether⁷ | — | 5.00 | — | — | — |
| Propylene glycol n-butyl ether⁸ | — | — | 5.00 | — | — |
| Dipropylene glycol n-butyl ether⁹ | | | | 5.00 | — |
| Minors (including perfume, dyes, | up to | up to | up to | up to | Up to |
| and preservative) and Water | 100% | 100% | 100% | 100% | 100% |
| pH (through NaOH) | 3 | 3 | 3 | 3 | 3 |

*Comparative
¹¹commercially available from Jungbunzlauer Ladenburg Gmbh
¹²commercially available from BASF

The average breakthrough time is shown in the table below:

| | F | G | H | I | J* |
|---|---|---|---|---|---|
| Average breakthrough time (s) | 72 | 68 | 49 | 53 | 143 |

*Comparative

As can be seen from the table above, compositions of the present invention, comprising a glycol ether solvent according to formula I (Dowanol PnB, Dowanol DPnB) or formula II (Dowanol PnP, Dowanol DPnP), improve the penetration of the composition through hydrophobic material, such as oil. Since the solvent improves penetration of the liquid composition into the stain, the improved surfactancy improves the dispersion of such hydrophobic stains within the acidic pH formulation.

The alkaline compositions below are non-limiting embodiments of the present invention:

| | K | L | M | N | O | P | Q | R | S |
|---|---|---|---|---|---|---|---|---|---|
| | wt % | wt % | wt % | wt % | wt % | wt % | wt % | wt % | wt % |
| Neodol 91-8² | 3 | — | 7.0 | — | — | — | 6.0 | 6.0 | 6.2 |
| C9/11EO5¹³ | — | 5 | — | 3.5 | — | — | — | — | — |
| C13/15 EO30¹⁴ | — | — | — | 3.5 | — | — | — | — | — |
| C8/10 EO8¹⁵ | 2 | | — | — | 7.0 | 6.0 | — | — | — |
| NaLAS¹⁶ | 5 | | 1.8 | — | — | 2.60 | — | 2.25 | 1.80 |
| NAPS¹⁷ | — | — | — | 3.1 | 3.0 | — | 2.60 | — | — |
| C12-14 Dimethyl | 2 | 5 | 1.50 | 3.9 | 2.0 | 3 | 2 | 1.25 | 1.50 |
| Amine Oxide³ | | | | | | | | | |
| C12-14 Betaine¹⁸ | — | — | — | — | 1.0 | — | 2 | — | — |
| Hydrophobically | — | — | 0.75 | — | — | — | 0.70 | 0.65 | 0.65 |
| modified- | | | | | | | | | |
| polyacrylate¹⁰ | | | | | | | | | |
| HM-HEC¹⁹ | — | — | — | 0.6 | 0.8 | — | — | — | — |
| Xanthan gum²⁰ | — | — | — | — | — | 0.42 | — | — | — |
| Na₂CO₃ | 0.40 | 0.4 | 0.75 | 0.1 | 0.3 | 0.50 | 0.55 | 0.4 | 0.55 |
| Citric Acid | 0.30 | 0.3 | 0.3 | 0.75 | 0.75 | 0.30 | 0.3 | 0.3 | 0.30 |
| Caustic | 0.25 | 0.25 | 0.72 | 0.5 | 0.5 | 0.3 | 0.65 | 0.65 | 0.66 |
| Fatty Acid | 0.15 | — | 1.0 | 0.20 | 0.50 | 0.50 | 0.40 | 0.40 | 1.0 |
| Propylene glycol | 5 | — | — | — | 3 | — | 4 | — | 2 |
| n-propyl ether⁵ | | | | | | | | | |
| Dipropylene | — | 4 | — | — | 3 | — | — | 3 | — |
| glycol n-propyl | | | | | | | | | |
| ether⁶ | | | | | | | | | |
| Propyleneglycol | — | — | 6 | — | — | 4 | 3 | — | — |
| ether n-butyl | | | | | | | | | |
| ether⁷ | | | | | | | | | |
| Dipropylene | — | — | — | 4 | — | 2 | — | 3 | 4 |
| glycol n-butyl | | | | | | | | | |
| ether⁸ | | | | | | | | | |
| DTPA²¹ | — | — | — | — | — | — | 0.25 | 0.25 | — |
| GLDA²² | — | — | — | 0.3 | 0.3 | — | — | — | — |
| IPA²³ | — | — | — | — | — | 2.0 | — | — | — |
| Minors and Water | up to | up to | up to | up to | up to | up to | up to | up to | up to |
| | 100% | 100% | 100% | 100% | 100% | 100% | 100% | 100% | 100% |
| pH | 10.5 | 10.3 | 10.3 | 9.5 | 9.0 | 10.5 | 10.3 | 10.5 | 10.3 |

¹³nonionic surfactant commercially available from ICI or Shell.
¹⁴nonionic surfactant commercially available from BASF
¹⁵nonionic surfactant commercially available from Sasol
¹⁶sodium linear alkylbenzene sulphonate commercially available from Huntsman
¹⁷sodium paraffin sulphonate commercially available from ICS
¹⁸amphoteric surfactant commercially available from MC Intyre group
¹⁹Hydrophobically modified hydroxyethylcellulose (cetylhydroxethylcellulose)
²⁰Kelzan T, commercially available from CP Kelco
²¹diethylene triamine pentaacetate, available from BASF
²²Tetrasodium Glutamate Diacetate, commercially available from Akzo Nobel
²³isopropanol, commercially available from J T Baker

Example compositions K to S exhibit good or excellent hydrophobic stain removal.

The following acidic compositions were made comprising the listed ingredients in the listed proportions (weight %). The examples herein exemplify the present invention but are not necessarily used to limit or otherwise define the scope of the present invention.

| Examples: | T | U | V | W | X | Y | Z | AA | AB |
|---|---|---|---|---|---|---|---|---|---|
| Formic acid¹² | 4.0 | 2.0 | 1.8 | 1.8 | 2.5 | 2.0 | 2.0 | 2.0 | 4.0 |
| Acetic acid²⁴ | — | 3.5 | 8.0 | 8.0 | 3.0 | 6.0 | 7.0 | — | — |
| Citric acid¹¹ | — | — | — | — | — | — | — | 8.0 | 2.0 |
| Lactic acid²⁴ | — | — | — | 1.0 | 2.0 | — | 1.0 | — | 1.5 |
| Neodol 91-8² | 0.5 | 2.2 | 2.2 | 2.2 | 1.5 | 0.45 | 2.5 | 1.8 | 2.0 |
| Sulphated Safol 23²⁵ | 2.0 | — | — | — | 1.0 | 2.0 | — | — | — |
| Kelzan T²⁰ | 0.40 | 0.25 | 0.25 | 0.25 | 0.25 | 0.10 | 0.40 | 0.30 | 0.25 |
| PVP²⁶ | 0.25 | 0.05 | 0.05 | 0.25 | 0.05 | — | 0.25 | 0.10 | 0.05 |
| Propylene glycol | 5 | — | — | — | 2 | — | 2 | — | 3 |
| n-propyl ether⁶ | | | | | | | | | |
| Dipropylene glycol | — | 3 | — | — | 2 | — | — | 4 | — |
| n-propyl ether⁷ | | | | | | | | | |
| Propylene glycol | — | — | 4 | — | — | 3 | 4 | — | — |
| n-butyl ether⁸ | | | | | | | | | |
| Dipropylene glycol | — | — | — | 6 | — | 3 | — | 2 | 3 |
| n-butyl ether⁹ | | | | | | | | | |
| KOH - to pH: | 2.3 | — | 2.9 | 2.8 | 2.8 | — | — | — | — |
| NaOH - to pH: | — | 2.2 | — | — | — | 2.5 | 2.3 | 2.0 | 2.2 |
| Minors and Water: | up to | up to | up to | up to | up to | up to | up to | up to | up to |
| | 100% | 100% | 100% | 100% | 100% | 100% | 100% | 100% | 100% |

²⁴lactic acid and acetic acid are commercially available from Aldrich.
²⁵Sulphated Safol 23 is a branched C12-13 sulphate surfactant based on Safol 23 an alcohol commercially available from Sasol, which has been sulphated.
²⁶PVP is a vinylpyrrolidone homopolymer, commercially available from ISP Corporation

Example compositions T to AB exhibit good or excellent limescale removal performance and hydrophobic stain removal, whilst providing good surface safety on the treated surface.

The impact of the glycol ether solvents according to the invention has also been assessed towards their ability to sustain suds over time when added to a detergent composition. The following liquid hard surface cleaning compositions, suitable for use as hand dishwashing detergent compositions, have been prepared by simple mixing of the individual raw materials:

| | AC | AD | AE | AF* |
|---|---|---|---|---|
| | wt % | wt % | wt % | wt % |
| C1213alkyl ethoxy (0.6) sulfate¹ | 22.8 | 22.8 | 22.8 | 22.8 |
| C1214 dimethyl amine oxide³ | 8.0 | 8.0 | 8.0 | 8.0 |
| Lutensol XP80²⁷ | 0.45 | 0.45 | 0.45 | 0.45 |
| NaOH | 0.53 | 0.53 | 0.53 | 0.53 |
| NaCl | 1.2 | 1.2 | 1.2 | 1.2 |
| Propyleneglycol | 2.0 | 2.0 | 2.0 | 2.0 |
| Ethanol | 4.0 | 4.0 | 4.0 | 6.4 |
| Sodium cumene sulphonate | 3.0 | 3.0 | 3.0 | 3.0 |
| Dipropylene glycol n-propyl | 10 | — | — | — |
| ether⁶ | | | | |
| Propylene glycol n-butyl ether⁷ | — | 10 | — | — |
| Dipropylene glycol n-butyl ether⁸ | — | — | 10 | — |
| Minors (including perfume, dyes, | To | To | To | To |
| and preservative) and Water | 100% | 100% | 100% | 100% |
| pH (measured as 10% dilution in | 9.0 | 9.0 | 9.0 | 9.0 |
| demi water at 20 degrees C.) | | | | |

*Comparative
¹anionic surfactant produced by P&G CHemicals
²⁷nonionic surfactant commercially available from BASF

10 g of each the above samples have been added to glass vials (diameter 2 cm, height 8.5 cm), which have then been closed. All of the vials were placed into a rack and manually shaken together for 20 seconds in an upwards downwards movement (10 to 15 cm up from the start point and 10 to 15 cm down back to the start point) at a constant frequency of 1 upwards-downwards shake per second. The foam height in each sample was measured straight after shaking and remeasured after 1 hr.

The table below shows the foam heights measured for the different samples:

| | AC | AD | AE | AF* |
|---|---|---|---|---|
| Suds height immediately after | 4 cm | 4.5 cm | 3.5 cm | 2 cm |
| shaking | | | | |
| Suds height after 1 hour | 2.5 cm | 2.2 cm | 3 cm | 1 cm |

As can be seen from the table above, compositions of the present invention, comprising a glycol ether solvent according to formula I (Dowanol PnB, Dowanol DPnB) or formula II (Dowanol DPnP), boost both initial foam height as well as help sustaining the foam height over time compared to the nil glycol ether comparative example formula AF*.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “40 mm”.

What is claimed is:

1. A method of treating hydrophobic stains from surfaces and/or for providing suds longevity comprising the step of providing a glycol ether solvent in a liquid cleaning composition comprising surfactant and having a pH of less than about 10, for treating hydrophobic stains from surfaces and/or for providing suds longevity,
wherein the glycol ether solvent is selected from the group consisting of glycol ethers of:
i. Formula I: R₁O(R₂O)ₙR₃;
ii. Formula II: R₄O(R₅O)ₘR₆; and
iii. mixtures thereof;
wherein:
R₁ is a linear or branched C₄, C₅ or C₆ alkyl or a substituted or unsubstituted phenyl,
R₂ is ethyl or isopropyl, R₃ is hydrogen or methyl, and n is 1, 2 or 3;
R₄ is n-propyl or isopropyl, R₅ is isopropyl, R₆ is hydrogen or methyl and m is 1, 2 or 3.

2. The method according to claim 1, wherein the hydrophobic stain is selected from the group consisting of: oils, fats, polymerized grease, and mixtures thereof.

3. The method according to claim 1, wherein the hydrophobic stain is a vegetable oil, preferably a vegetable oil selected from the group consisting of: sesame oil, canola oil, olive oil, rapeseed oil, coconut oil, corn oil, peanut oil, sunflower oil, and mixtures thereof.

4. The method according to claim 1, wherein the surfactant and the glycol ether solvent are in a weight ratio of from 5:1 to 1:1.

5. The method according to claim 1, wherein the surfactant comprises a nonionic surfactant selected from the group consisting of: alkoxylated nonionic surfactants, alkyl polyglycosides, amine oxides, and mixtures thereof.

6. The method according to claim 1, wherein the surfactant system comprises an anionic surfactant and an amphoteric and or a zwitterionic surfactant, wherein the anionic surfactant and the amphoteric and or the zwitterionic surfactant are in a weight ratio of less than 9:1.

7. The method according to claim 1, wherein the anionic surfactant is an alkoxylated anionic surfactant, wherein the alkoxylated anionic surfactant has an average alkoxylation degree of from about 0.2 to about 3.

8. The method according to claim 1, wherein the surfactant system comprises an amphoteric surfactant and wherein the amphoteric surfactant comprises at least about 60% by weight of an amine oxide surfactant.

9. The method according to claim 1, wherein the surfactant system comprises an amphoteric and a zwitterionic surfactant wherein the amphoteric and the zwitterionic surfactant are in a weight ratio of from about 2:1 to about 1:2

10. The method according to claim 1, wherein the composition further comprises a co-solvent selected from the group consisting of: C2-C4 alcohols, C2-C4 polyols, poly alkylene glycol and mixtures thereof.

11. The method according to claim 1, wherein the surface is tableware selected from the group consisting of: ceramics, glass, metal cutlery, and combinations thereof.

12. The method of according to claim 1, for providing suds longevity, wherein the composition provides a suds height after about 1 hour of greater than about 1.5 cm as measured using the foam height method described herein.

13. A method of removing hydrophobic stains from a surface, comprising the steps of:
a) optionally pre-wetting the hard surface;
b) applying a liquid cleaning composition having a pH of less than about 10 and comprising surfactant and a glycol ether solvent selected from the group consisting of glycol ethers of:
i. Formula I: R₁O(R₂O)ₙR₃;
ii. Formula II: R₄O(R₅O)ₘR₆; and
iii. mixtures thereof;
wherein:
R₁ is a linear or branched C₄, C₅ or C₆ alkyl or a substituted or unsubstituted phenyl,
R₂ is ethyl or isopropyl, R₃ is hydrogen or methyl, and n is 1, 2 or 3;
R₄ is n-propyl or isopropyl, R₅ is isopropyl, R₆ is hydrogen or methyl and m is 1, 2 or 3;
c) optionally rinsing or wiping the hard surface with water;

14. The method according to claim 13, wherein the liquid cleaning composition comprises a surfactant, present at above the critical micelle concentration of the surfactant.

15. The method according to claim 13, wherein the surfactant system comprises an anionic surfactant and an amphoteric and or a zwitterionic surfactant wherein the anionic surfactant and the amphoteric and or the zwitterionic surfactant preferably are in a weight ratio of less than about 9:1.

16. The method according to claim 13, wherein the liquid cleaning composition is applied using a spray.

17. The method according to claim 13, further comprising rinsing or wiping the hard surface with water, and wherein the liquid cleaning composition is left on the hard surface for at least about 15 seconds and, before the rinsing or wiping step.

18. The method according to claim 13, wherein the hydrophobic stain has been left on the surface for at least about 1 hour.

19. A liquid cleaning composition for treating hydrophobic stains on surfaces, having a pH of less than about 10 and comprising:
a) a surfactant;
b) a glycol ether solvent
wherein the glycol ether solvent is selected from the group consisting of glycol ethers of:
iv. Formula I: R₁O(R₂O)ₙR₃;
v. Formula II: R₄O(R₅O)ₘR₆; and
vi. mixtures thereof;
wherein:
R₁ is a linear or branched C₄, C₅ or C₆ alkyl or a substituted or unsubstituted phenyl, R₂ is ethyl or isopropyl, R₃ is hydrogen or methyl, and n is 1, 2 or 3;
R₄ is n-propyl or isopropyl, R₅ is isopropyl, R₆ is hydrogen or methyl and m is 1, 2 or 3; and
c) a chelant.
